(19) United States
(12) Patent Application Publication
(10) Pub. No.: US 2025/0055279 A1
(43) Pub. Date: Feb. 13, 2025

(54) LOAD MANAGEMENT SYSTEMS FOR ELECTRIC GRIDS

(71) Applicant: Aclara Technologies LLC, St. Louis, MO (US)

(72) Inventor: David Donald Haynes, St. Peters, MO (US)

(21) Appl. No.: 18/797,082

(22) Filed: Aug. 7, 2024

Related U.S. Application Data
(60) Provisional application No. 63/518,352, filed on Aug. 9, 2023.

(51) Int. Cl. H02J 3/00; B60L 53/63; H02J 13/00

(52) U.S. Cl. CPC H02J 3/0075; B60L 53/63; H02J 13/00002; H02J 13/00006

(57) ABSTRACT

Systems and methods for load management for electric grids. An example load management system includes a load management server associated with a utility and a first revenue meter communicatively connected to the load management server. The first revenue meter includes a first controller configured to determine a user priority of load distribution to a plurality of devices in communication with the first revenue meter and determine a current power drawn by the plurality of devices. The first controller is configured to transmit, in response to a load shed event and based on the user priority, a load shed command to the plurality of devices indicating a new amount of power to be drawn by the plurality of devices, and transmit an indication of the load shed event to the load management server.

### RELATED APPLICATIONS

This application claims the benefit of U.S. Provisional Patent Application No. 63/518,352, filed Aug. 9, 2023, the entire content of which is hereby incorporated by reference.

### FIELD

Embodiments disclosed herein relate to load management for electric grids.

### BACKGROUND

It is common for multiple electrical services to share a common service transformer. The proliferation of electric vehicles has resulted in a significant change to the utility grid load. For example, a single electric vehicle charging load is equivalent to two central-air air conditioning loads and can more than double the load on the respective service transformer. Moreover, electric vehicle charging loads are present year-round. Electric utilities are aware of this ever-increasing demand for electricity and have deployed electric vehicle supply equipment to service electric cars on the grid.

### SUMMARY

Approximately 48 million homes in the United States still contain 100A service to their load centers. As homeowners upgrade equipment in their homes, service may be needed to upgrade the home to accommodate today's increased electrical demand. Electric vehicle supply equipment (EVSE) is now being installed in homes to manage the charging of electric vehicles. These EVSEs add additional strain onto load center, particularly when used in combination with ovens, stoves, dryers, air conditioners, and other high-power appliances. The addition of EVSEs may result in a service drawing full power and exceeding the capacity of a service transformer.

Utilities may curtail loads during times of high usage to keep power below the capacity of the service transformers. However, curtailing loads should be performed in a manner that does not inconvenience consumers that may opt out of load control programs. Embodiments described herein provide load control systems that implement load shedding, including shedding electric vehicle charging, to preserve service transformers and other distribution and transmission infrastructure. Load control may also be used to address power generation shortfalls. Embodiments described herein shed loads to meet local needs, distribution needs, transmission infrastructure means, and/or regional needs according to consumer assigned priorities.

According to one example, a load management system includes a load management server associated with a utility and a first revenue meter communicatively connected to the load management server. The first revenue meter includes a first controller configured to determine a user priority of load distribution to a plurality of devices in communication with the first revenue meter and determine a current power drawn by the plurality of devices. The first controller is configured to transmit, in response to a load shed event and based on the user priority, a load shed command to the plurality of devices indicating a new amount of power to be drawn by the plurality of devices, and transmit an indication of the load shed event to the load management server. The new amount of power to be drawn is less than the current power drawn by the plurality of devices.

In some aspects, the load management system further includes a service transformer configured to receive power from the utility, and the first controller is further configured to monitor an amount of power output by the service transformer.

In some aspects, the first controller is further configured to determine the load shed event when the current power drawn by the plurality of devices exceeds a power threshold. In some aspects, the power threshold is a power rating of the service transformer.

In some aspects, the first controller is further configured to transmit a registration message to the load management server, the registration message including an identification number of the first revenue meter.

In some aspects, the load management system further includes a second revenue meter communicatively connected to the load management server. The second revenue meter includes a second controller configured to transmit a request to the load management server requesting an identification of the first revenue meter and establish communication with the first revenue meter.

In some aspects, the first controller is further configured to receive, from the second revenue meter, a request for power, and transmit a power command to the second revenue meter indicating a permitted amount of power draw.

In some aspects, the user priority indicates an order in which power is reduced to the plurality of devices.

In some aspects, the plurality of devices includes an electric vehicle.

According to another example, a load management system includes a service transformer configured to provide power, a plurality of revenue meters, and a cohort leader communicatively connected to each revenue meter of the plurality of revenue meters. The service transformer includes a transformer rating indicating a maximum providable power. Each revenue meter of the plurality of revenue meters is coupled to at least one load and is configured to receive power from the service transformer. The cohort leader includes a controller configured to receive a plurality of power requests, each power request being received from one of the plurality of revenue meters, determine, based on the plurality of power requests and the transformer rating, a plurality of power allocations, and transmit one power allocation of the plurality of power allocations to each revenue meter included in the plurality of revenue meters.

In some aspects, each power request is a percentage of power available from the service transformer, and the controller is further configured to multiply, for each power request, the power request and the transformer rating to determine the plurality of power allocations.

In some aspects, the controller is further configured to receive a plurality of instantaneous power measurements, each instantaneous power measurement received from one of the plurality of revenue meters and indicative of the current power draw of the associated revenue meter. The controller is configured to sum the plurality of instantaneous power measurements to determine a current instantaneous power measurement and subtract the current instantaneous power measurement from the transformer rating to determine a margin power available to each revenue meter.

In some aspects, each power request is a percentage of power available from the service transformer, and the controller is further configured to multiply the margin power with the power request to determine a power portion and add, for each instantaneous power measurement, the power portion to the instantaneous power measurement to determine the plurality of power allocations.

In some aspects, the cohort leader is connected to an electric vehicle supply equipment (EVSE), and the controller is further configured to transmit a shed load command to the EVSE instructing the EVSE to reduce power drawn from the service transformer.

In some aspects, the controller is further configured to determine whether a first revenue meter of the plurality of revenue meters is exceeding a respective power allocation and log, in a memory of the controller, an indication of the first revenue meter exceeding the respective power allocation.

According to another example, a method for controlling power draw from a service transformer includes determining, with a first revenue meter, a user priority of load distribution to a plurality of devices in communication with the first revenue meter and determining a current power drawn by the plurality of devices. The method includes transmitting, in response to a load shed event and based on the user priority, a load shed command to the plurality of devices indicating a new amount of power to be drawn by the plurality of devices and transmitting an indication of the load shed event to a load management server associated with the service transformer. The new amount of power to be drawn is less than the current power drawn by the plurality of devices.

In some aspects, the method further includes determining the load shed event when the current power drawn by the plurality of devices exceeds a power rating of the service transformer.

In some aspects, the method further includes transmitting a registration message to the load management server, the registration message including an identification number of the first revenue meter, and receiving, from the load management server, configuration information including the power rating of the transformer.

In some aspects, the method further includes transmitting, with a second revenue meter, a request to the load management server requesting an identification of the first revenue meter, and establishing, with the second revenue meter, communication with the first revenue meter.

In some aspects, the method further includes receiving, with the first revenue meter, a request for power from the second revenue meter, and transmitting, with the first revenue meter, a power command to the second revenue meter indicating a permitted amount of power draw.

Other aspects of the technology will become apparent by consideration of the detailed description and accompanying drawings.

### BRIEF DESCRIPTION OF THE DRAWINGS

FIG. 1 is a diagram illustrating an example electric vehicle charging system, according to some embodiments.

FIG. 2 is a circuit diagram of an example electric vehicle supply equipment, according to some embodiments.

FIG. 3 is a block diagram of an example load control system, according to some embodiments.

FIG. 4 provides example messages transmitted during installation of an EVSE, according to some embodiments.

FIG. 5 provides example messages transmitted during installation of a load control device, according to some embodiments.

FIG. 6 provides example messages transmitted during installation of a revenue meter, according to some embodiments.

FIG. 7 is a block diagram of another example load control system, according to some embodiments.

FIG. 8 provides example messages received and transmitted by a premises manager, according to some embodiments.

FIG. 9 provides example messages received and transmitted by a cohort manager, according to some embodiments.

FIG. 10 provides example messages received and transmitted by a load management system, according to some embodiments.

### DETAILED DESCRIPTION

One or more examples, embodiments, aspects, and features are described and illustrated in the following description and accompanying drawings. These examples are not limited to the specific details provided herein and may be modified in various ways. Other examples and embodiments may exist that are not described herein. For instance, a device or structure that is “configured” in a certain way is configured in at least that way but may also be configured in ways that are not listed. Some examples described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not include a transitory, propagating signal. Accordingly, non-transitory computer-readable medium may include, for example, a hard disk, a CD-ROM, an optical storage device, a magnetic storage device, ROM (Read Only Memory), RAM (Random Access Memory), register memory, a processor cache, other memory and storage devices, or combinations thereof.

The phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Relational terms, for example, first and second, top and bottom, and the like may be used herein solely to distinguish one entity or action from another entity or action without necessarily requiring or implying any actual such relationship or order between such entities or actions. Embodiments or portions of an embodiment can be combined with other embodiments or portions of other embodiments to create yet further embodiments, whether or not they are specifically illustrated or described.

It should also be understood that although certain drawings illustrate hardware and software located within particular devices, these depictions are for illustrative purposes only. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

In some instances, method steps are conducted in an order that is different from the order described. Additionally, in some instances, rather than occurring concurrently, some method steps may instead occur simultaneously.

### Electric Vehicle Charging Systems

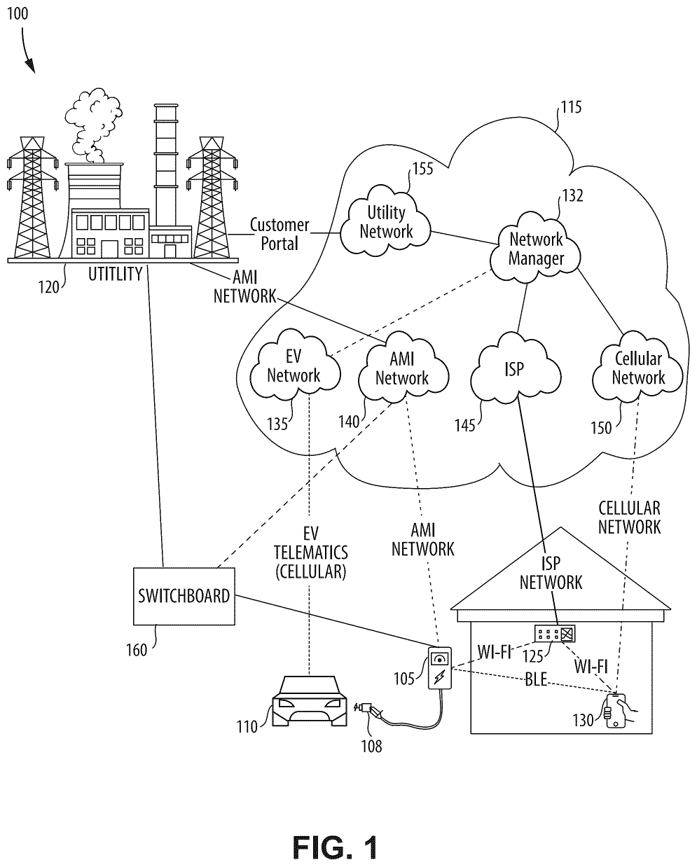

FIG. 1 illustrates an example charging system 100 including an electric vehicle supply equipment (EVSE) 105 and an electric vehicle 110 (for example, a plug-in electric vehicle or a plug-in hybrid electric vehicle). The EVSE 105 is configured to supply power to the electric vehicle 110 via a charging receptacle (e.g., a charging outlet, a charging port) 108. The charging receptacle 108 may be, for example, a SAE J1772 charging port, an IEC 61851 charging port, an IEC 62196 charging port, a Combined Charging Standard (CCS)-type charging port, or other similar charging receptacle. In some instances, multiple electric vehicles 110 are connected to and receive power from the EVSE 105. The EVSE 105 is electrically connected to an electrical grid, such as utility 120 or a load center. The EVSE 105 may also include an advanced metering infrastructure (AMI), described below in more detail.

The charging system 100 further includes a network 115 including a plurality of sub-networks, such as, but not limited to, an electric vehicle network 135, an AMI network 140, an internet service provider (ISP) 145, a cellular network 150, and a utility network 155. In some instances, the network 115 includes a network manager 132 configured to control communications between each of the sub-networks, allowing each device within the charging system 100 to be communicatively connected.

In the example of FIG. 1, the electric vehicle 110 is communicatively coupled to the electric vehicle network 135. The electric vehicle network 135 provides, for example, global positioning system (GPS) information to the electric vehicle 110, troubleshooting information related to a status of the electric vehicle 110, and other operational data to the electric vehicle 110. The electric vehicle 110 provides, for example, status reports, charging information, positioning information, and other operational information to the electric vehicle network 135.

The EVSE 105 is communicatively coupled to a utility 120 (or, more particularly, a server associated with a utility service) via the AMI network 140. In some instances, the EVSE 105 provides status reports to the utility 120 via the AMI network 140, such as, for example, a charging schedule of the electric vehicle 110, an average charging power provided to the electric vehicle 110, a monthly charging power provided to the electric vehicle 110, and which electric vehicles 110 are registered with the EVSE 105. The utility 120 may transmit request signals to the EVSE 105, such as a request for the charging schedule of the EVSE 105, a request for the average charging power provided by the EVSE 105, a request for monthly charging power provided by the EVSE 105, and a request for a list of electric vehicles 110 registered with the EVSE 105. In some instances, the utility 120 transmits commands to the EVSE 105, such as remote disconnect commands to stop transmission of power by the EVSE 105, a current value or charge capacity to advertise to the electric vehicle 110, a command for a load shedding event, or the like.

In some instances, the EVSE 105 is communicatively coupled to a router 125 via, for example, Wi-Fi. The router 125 is then communicatively coupled to an internet service provider (ISP) 145 within the network 115. In further implementations, the EVSE 105 is communicatively coupled to a mobile device 130 via, for example, Bluetooth™. The mobile device 130 may be communicatively coupled to a cellular network 150.

A customer may access their utility account via the utility network 155 and a customer portal. The utility account may allow the customer or user to view settings of their EVSE 105, control charging schedules associated with the EVSE 105, override charging of the electric vehicle 110, adjust settings of the EVSE 105, adjust load shedding settings, and the like.

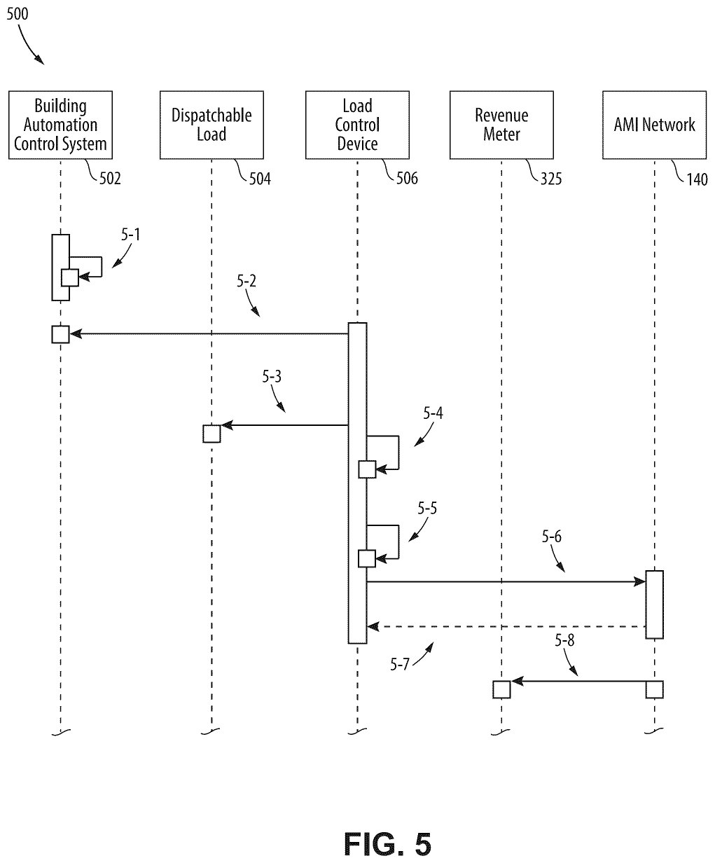

In some instances, the charging system 100 includes a main switchboard 160 (e.g., a panel, a fuse box, a distribution panel, a panel box, a breaker box, etc.) connected between the utility 120 and the EVSE 105. In some instances, the main switchboard 160 includes a house meter (not shown) to measure power usage of all components within a residence. Accordingly, in such an instance, the EVSE 105 is a sub-meter to the house meter. In other instances, the house meter is located separately from the main switchboard 160. In some embodiments, an AMI 210 included in the EVSE 105 (shown in FIG. 5) functions as the house meter. In embodiments where the AMI 210 is not included in the EVSE 105, the EVSE 105 may communicate with the utility 120 via the switchboard 160 or may communicate directly with the utility 120.

The main switchboard 160 may trip a fuse or breaker when the current flowing from the utility 120 through the main switchboard 160 exceeds a maximum current, such as 100 Amperes, to prevent damage to the EVSE 105 and the electric vehicle 110. In some embodiments, this may be corrected by reducing a rating of the EVSE 105 when the current draw from the main switchboard 160 exceeds the maximum current. The main switchboard 160 may also be configured to provide power to other electrical appliances, such as household appliances, chargers, and the like that are also connected to the main switchboard 160 to receive power from the utility 120.

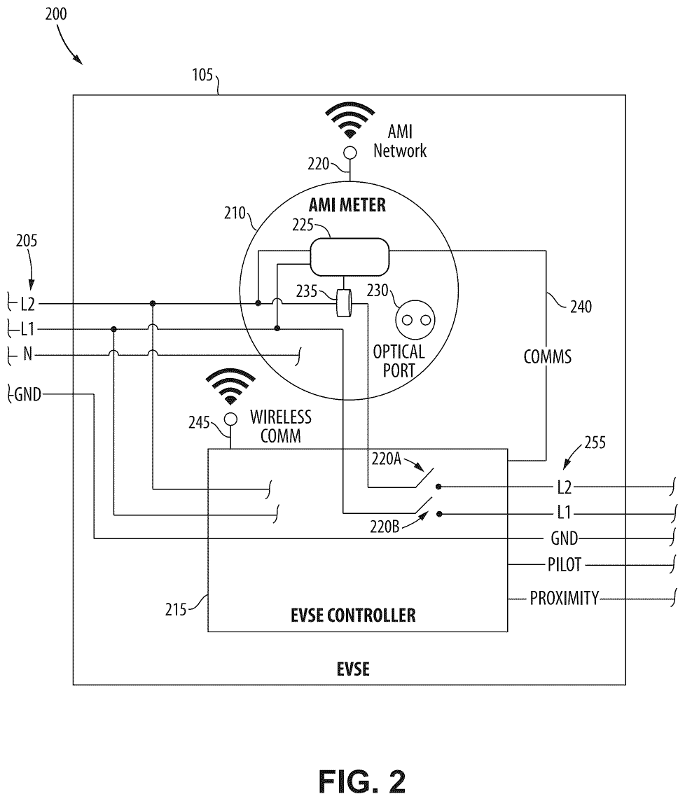

FIG. 2 provides a control system 200 for the EVSE 105. The EVSE 105 receives power from a power input 205 (such as power cable). In the illustrated example, the power input 205 is a NEMA 14-50 receptacle. However, other means for providing power to the EVSE 105 from a power grid may be used. For example, the EVSE 105 may be hardwired to the power grid, or another receptacle may be used. The power input 205 includes a first line power L1, a second line power L2, a neutral line N, and a ground line GND. The first line power L1, the second line power L2, and the neutral line are provided to an AMI meter 210 integrated within the EVSE 105. The first line power L1, the second line power L2, and the ground line GND are provided to an EVSE controller 215. The EVSE 105 may be configured to receive, for example, approximately 12 kW of power on a single-phase AC line.

The AMI meter 210 is configured to monitor power usage of the EVSE 105 via a sensor 235 (e.g., a voltage sensor, a current sensor, a power sensor, and the like). The AMI meter 210 includes an AMI antenna 220 configured for bi-directional communication over the AMI network 140. In some implementations, the AMI meter 210 includes an AMI controller 225. The AMI controller 225 includes an electronic processor and a memory (not shown). The AMI controller 225 is configured to communicate with the utility 120 using the AMI antenna 220. For example, the AMI controller 225 reports an amount of power used to charge a connected electric vehicle 110 to the utility 120 via the AMI network 140. The AMI controller 225 also receives requests and commands from the utility 120, such as requests for status reports and remote disconnect commands (as described below in more detail). The AMI antenna 220 may communicate over the AMI network 140 via, as some examples, radio frequency (RF), RF mesh, cellular power line carrier, ethernet, and other similar long-distance communication mediums.

In some instances, the AMI meter 210 includes an optical port 230. An operator of the AMI meter 210 may access data stored in a memory of the AMI controller 225, or otherwise service the AMI meter 210, via the optical port 230. In some instances, the AMI meter 210 is a single-phase residential ANSI C12 AMI. In some implementations, the AMI meter 210 includes interchangeable automated meter reading (AMR) and AMI modules.

In the example of FIG. 2, the EVSE controller 215 is powered by the first line power L1 and the second line power L2. The first power line L1 and the second power line L2 also travel through the AMI meter 210 (such that power along the lines is monitored) and provided to the EVSE controller 215 before being output at a power output 255 (e.g., the power receptacle 108). In the illustrated example, the power output 255 is an SAE J1772 charge coupler. However, other power receptacles may be implemented. By providing power to the EVSE controller 215 separately from the power provided to the electric vehicle 110, the AMI meter 210 monitors power used to charge the electric vehicle 110 separately from power used by the overall charging system 100. Additionally, in some embodiments, the power output 255 includes a communication terminal such that the EVSE 105 communicates with a connected electric vehicle 110, such as the PILOT terminal and PROXIMITY terminals shown in FIG. 2. For example, the EVSE 105 uses the PILOT terminal (e.g., a control pilot signal) to vary the current advertised to the electric vehicle 110. An advertised current may be a current value that the EVSE 105 tells the electric vehicle 110 is the maximum available current to be drawn for charging. The electric vehicle 110 then adjusts how much current is drawn for charging using electrical components within the electric vehicle 110. In some embodiments, the EVSE 105 indicates a maximum current value, a minimum current value, an intermediate current value, or no current value over the PILOT terminal. For example, the maximum current value may be a maximum current value that the electric vehicle 110 can safely pull, a minimum current value may be a minimum current value output by the EVSE 105 for charging, and a no current value may indicate that charging should not occur during this time. The EVSE 105 uses the PROXIMITY terminal to notify the electric vehicle 110 that the electric vehicle 110 is connected for charging. Accordingly, in some instances, the PILOT terminal and the PROXIMITY terminal are each communication terminals between the EVSE 105 and the electric vehicle 110.

The EVSE controller 215 includes an electronic processor and a memory (not shown). The memory includes, for example, a program storage area and a data storage area. The program storage area and the data storage area can include combinations of different types of memory, such as read-only memory (ROM) and random access memory (RAM). Various non-transitory computer readable media, for example, magnetic, optical, physical, or electronic memory may be used. The electronic processor is configured to implement data stored by the memory to perform operations and methods described herein.

The EVSE controller 215 may also be communicatively coupled to the AMI meter 210 via a communication line 240. The communication line 240 may be wired or wireless. The AMI meter 225 may transmit commands to the EVSE controller 215 based on signals received from the utility 120. For example, the utility 120 may wish to halt providing power via the power output 255 in response to a non-payment, for an emergency cut-off, for a demand response event (e.g., load shedding), or other similar situations. The utility 120 transmits a remote disconnect command to the AMI meter 210 via the AMI network 140. The AMI controller 225 receives the command from the utility 120 and transmits a command to the EVSE controller 215 to disconnect power to the power output 255. As one example, the EVSE controller 215 controls a first switch 250A and a second switch 250B to physically disconnect the first line power L1 and the second line power L2 from the power output 255. In other instances, the first switch 250A and the second switch 250B are logically representative of the EVSE controller 215 halting providing power to the power output 255 (such as, for example, setting a logical flag, stopping outputs from the EVSE controller 215, or the like). In some instances, when the EVSE controller 215 halts providing power to the power output 255, the EVSE controller 215 informs the electric vehicle 110 of upcoming actions the EVSE controller 215 will take via the PILOT terminal.

In some implementations, the remote disconnect command received by the AMI meter 210 is translated by the EVSE controller 215 as different current levels to advertise to the electric vehicle 110. In one example, a “remote disconnect ON” command may instruct the EVSE controller 215 to advertise to the electric vehicle 110 the maximum possible current, while a “remote disconnect OFF” command may instruct the EVSE controller 215 to advertise to the electric vehicle 110 the minimum possible current. In another example, the “remote disconnect ON” command may instruct the EVSE controller 215 to advertise to the electric vehicle 110 the maximum possible current, while the “remote disconnect OFF” command may instruct the EVSE controller 215 to advertise that the EVSE 105 is not prepared to charge the electric vehicle 110 or that the EVSE 105 is not capable of charging the electric vehicle 110 (e.g., is not receiving power from the utility 120).

In some implementations, the EVSE controller 215 monitors a presence of the ground line GND. Should an event occur where the ground line GND is no longer present or operational, the EVSE controller 215 controls the first switch 250A and the second switch 250B to disconnect the first line power L1 and the second line power L2 from the power output 255.

In some implementations, the EVSE controller 515 includes an EVSE antenna 245 configured for local wireless communication. For example, and with reference to FIG. 1, the EVSE 105 uses the EVSE antenna 245 to communicate with the router 125 over a Wi-Fi network and the mobile device 130 over a Bluetooth™ network. The EVSE controller 215 communicates with the mobile device 130 (or another device communicatively coupled to the EVSE controller 515 via the router 125) using the EVSE antenna 245. For example, the mobile device 130 may set settings or configurations of the EVSE controller 215, view energy reports associated with energy provided to an electric vehicle 110, or the like.

In some implementations, the EVSE controller 215 and the AMI meter 210 are separate pluggable modules that plug into a common EVSE housing, allowing for the EVSE controller 215 and the AMI meter 210 to be serviced independently of one another. In some implementations, the EVSE 105 may include a meter shunt in place of the AMI meter 210. During installation, the EVSE 105 is installed with the EVSE controller 515 and the meter shunt. The AMI meter 210 may then be installed in the EVSE 105 in place of the meter shunt after the initial installation.

In some instances, the AMI controller 225 is a master device that transmits command packets (e.g., data packets) to the EVSE controller 215 (which is a slave device). After receiving the command packets, the EVSE controller 215 transmits either a positive or negative acknowledgement to the AMI controller 225. If the AMI controller 225 fails to receive an acknowledgement before a time-out period (for example, 750 ms), or a negative acknowledgement is received by the AMI controller 225, the AMI controller 225 re-transmits the command packet to the EVSE controller 215. Should the transmission fail a predetermined period of times (for example, three times), the AMI controller 225 assumes an error has occurred. In some embodiments, the command packets include 8 data bits, 1 start bit, and 1 stop bit. In some embodiments, the command packets include parity bits. Table 1 provides example command packets transmitted from the AMI controller 225 to the EVSE controller 215.

TABLE 1
Command Packets

| | Message | | | |
|---|---|---|---|---|
| | Response | | | |
| Command | Data | ID | Message Contents | Charger Response |
| Charge control - allow | No | 0xF0 | Not used - set to 0s | 0xF0 + response byte |
| | | | | (0 = accepted, no error; |
| | | | | otherwise error occurred) |
| Charge control - | No | 0xF1 | Not used - set to 0s | 0xF1 + response byte |
| disallow | | | | (0 = accepted, no error; |
| | | | | otherwise error occurred) |
| Read charger status | Yes | 0xF2 | Not used - set to 0s | 0xF2 + response byte (status |
| | | | | bitfields to be defined) |

While only the electric vehicle 110 is illustrated as being connected to the EVSE 105, in some implementations the EVSE 105 functions as the main switchboard 160. Accordingly, a plurality of dispatchable loads may be connected to the EVSE 105 to receive power, such as household appliances, chargers, and the like.

### Load Control Systems and Load Shedding

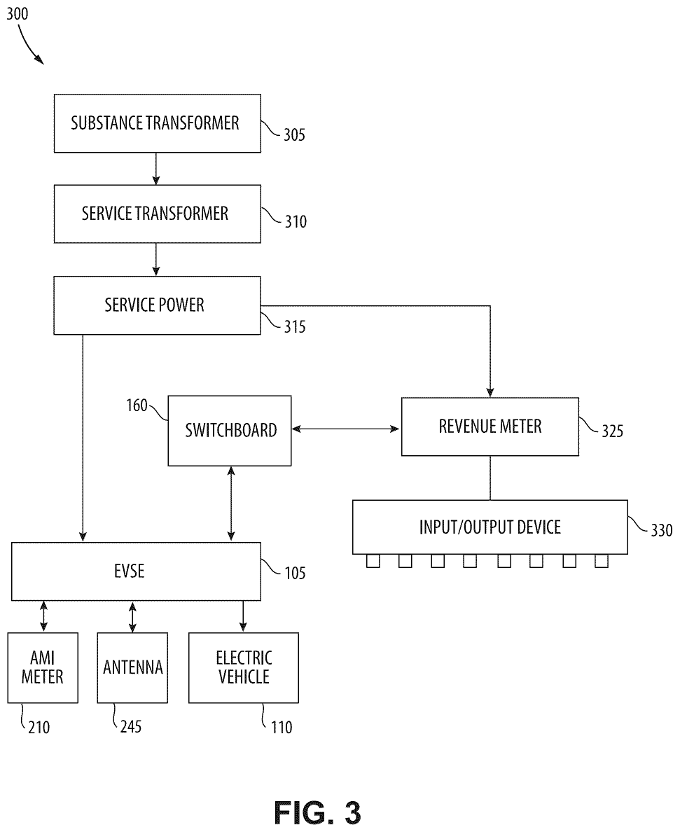

Embodiments described herein configure meters with load management operations. The meters may include the AMI 210 or a meter associated with the utility 120. For example, FIG. 3 illustrates an example load control system 300. The load control system 300 includes, among other things, a substation transformer 305 and a service transformer 310. The substation transformer 305 steps voltage down from a transmission level to a distribution level for distribution to connected loads. The service transformer 310 steps voltage down from the distribution voltage to a service voltage. The service voltage is provided to loads as the service power 315. The service power 315 may be an agreed upon voltage and maximum current that is delivered by the utility 120. The substation transformer 305 and the service transformer 310 may be part of the utility 120.

Meters that receive power from a given service transformer 310 are part of a local “cohort” of meters that collaborate to share power. For example, revenue meters, such as revenue meter 325, are responsible for their own load and perform load management functions to perform load shed operations, as described below in more detail. In some embodiments, one revenue meter 325 in the cohort is the primary revenue meter 325 that functions as the “cohort leader”. The primary revenue meter 325 may be responsible for rationing power to the remaining revenue meters within the cohort. The primary revenue meter 325 is connected to the other revenue meters within the cohort via input/output device 330 (e.g., a serial input/output device). Accordingly, all revenue meters within a cohort are communicatively connected.

The EVSE 105 receives the service power 315 and uses the service power 315 to charge the electric vehicle 110. In the example of FIG. 3, the EVSE 105 is connected to revenue meter 325 via the switchboard 160. In other instances, the EVSE 105 may be directly connected to the revenue meter 325. However, by connecting to the switchboard 160, the revenue meter 325 may have a full understanding of the electrical load drawn by all components within a residence. In the example of FIG. 3, the revenue meter 325 is the primary revenue meter. The revenue meter 325 may transmit commands to the EVSE 105 related to load shedding events (e.g., load shed events), as described below in more detail.

The revenue meter 325, acting as the cohort leader, receives present and forecasted load requests from the other revenue meters within the cohort. The revenue meter 325 processes the load requests from the other revenue meters within the cohort, sums the load requests together, and compares the total load requested to the spare capacity of the service transformer 310. If there is enough spare capacity available from the service transformer 310 for all the load requests, then all the load requests get approved at 100%. If there is not enough spare capacity from the service transformer 310 for all the load requests, then rationing rules are applied by the revenue meter 325.

One example rationing rule is referred to herein as proportional rationing. Proportional rationing limits the service power 315 to its own “transformer portion.” “Transformer portion” as defined herein refers to the fractional amount of power a service (e.g., a load) may draw from the service transformer 310 by virtue of the contractual service size relative to the aggregate of the services served by the service transformer 310. The transformer portion is provided by Equation 1:

$${TransformerPortion}_{j} = \frac{{ServiceRating}_{j}}{{\sum }_{i = 1}^{n} {ServiceRating}_{i}} \qquad [ Equation 1 ]$$

Where j is a service and a given service transformer 310 provides power to n services.

For example, if a service transformer 310 is dedicated to a single service, that service will have a transformer portion of 100%. If the service transformer 310 serves two services of equal size, each service has a transformer portion of 50%. Equation 1 describes a service's claim to the capacity of a service transformer 310.

Additionally, with proportional rationing, the service power 315 drawn by a service is the service transformer rating multiplied by the service's transformer portion, as provided by Equation 2:

$${PowerAllocation}_{j} = {TransformerPortion}_{j} \times {TransformerRating}_{kVA} \qquad [ Equation 2 ]$$

In some instances, if a load exceeds its power apportionment over the course of a demand period, the revenue meter 325, the EVSE 105, or both log an alarm message.

Another example rationing rule is referred to herein as margin power monitoring. Margin power monitoring considers the actual power used and awards what is available to the revenue meters that request it. “Margin power” as defined herein refers to the spare unused capacity at a service transformer 310, and is provided by Equation 3:

$${MarginPower}_{kVA} = Transformer {Rating}_{kVA} - {\sum }_{i = 1}^{n} {InstantaneousPower}_{i} \qquad [ Equation 3 ]$$

Equation 3 includes an instantaneous power measurement from the revenue meters that is reported to the cohort leader (e.g., the revenue meter 325). The measurement may be updated periodically, such as once every minute. Under margin power monitoring, each revenue meter monitors the margin power available at its respective service transformer 310. When the margin power becomes small (or, in some instances, becomes negative), each revenue meter performs load control and sheds loads available to the respective revenue meter, in an order prescribed by an operator of the revenue meter, until proper margins are maintained, or all loads have been dispatched. Additionally, if a violation of the margin power monitoring is detected by one of the revenue meters, the revenue meter logs the violation and reports the violation to the utility 120 (for example, via the AMI network 140).

Another example rationing rule is referred to herein as proportion to amount requested. During the proportion to amount requested rationing rule, the forecasted power need over a predetermined period of time is regularly computed. The predetermined period of time may be, for example, the forecasted power need over the next minute. The revenue meter measures the current instantaneous power usage and predicts the power usage over the next demand interval. Revenue meters in a cohort send their forecasts to the cohort leader (e.g., the primary revenue meter 325), who in turn sums the forecasts. The power allocation is predicted according to Equation 4:

$$[ Equation 4 ]$$

$${PowerAllocation}_{j} = \{ \frac{\begin{matrix}{PowerForecast}_{j} , if ( {\sum }_{i = 1}^{n} {PowerForecast}_{i} ) < \\ {TransformerRating}_{kVA}\end{matrix}}{\frac{{PowerForecast}_{j}}{{\sum }_{i = 1}^{n} {PowerForecast}_{i}} \times {TransformerRating}_{kVA} , else}$$

For meter j amongst a population of n meters under a common service transformer 310. Power allocation is the power awarded to a given revenue meter for the upcoming demand interval.

When a given revenue meter observes that its usage exceeds its allocation over the course of the demand interval, the revenue meter logs the event and reports the event to the utility 120 (for example, via the AMI network 140).

Yet another example rationing rule is referred to as margin power allocation. During margin power allocation, margin power is computed for a given service transformer 310 as previously described with respect to Equation 3. Margin power is then awarded in proportion to service size (e.g., load size) regardless of the forecasted power requirements. The power allocation is determined as provided by Equation 5:

Power Allocationⱼ=InstantaneousPowerⱼ+TransformerPortionⱼ×MarginPower_{kVA} [Equation 5]

Where power allocation is the power awarded by the cohort leader to a revenue meter j over the next demand interval. The demand interval referred to herein is the length of time identified by the utility 120 over which transformer heating is tracked. The length of time may be, for example, 10 minutes, 15 minutes, 20 minutes, or the like. In some instances, the margin power may be negative. In such an instance, each service may be trimmed back proportionately.

Further load control schemes may be considered in addition to the rationing rules described above. For example, in many cases it may be desired to incentivize the adoption of load control within homes so that dispatchable loads can be identified and utilized. Consumers may be given the option to opt-out of a load shed program or restrictions placed on them by the local, likely overloaded service transformer 310.

Components of the load control system 300, such as the revenue meter 325 and the EVSE 105, may be configured to control power to dispatchable loads, such as other EVSEs, air conditioners, pool pumps, irrigation pumps, lighting, hot water heaters, building automation controllers, metered services, and the like. Some dispatchable loads may be “smart” devices, such as a hot-water heater having a pluggable communication module. In such instances, a dedicated load control device may be installed to interface with the smart device. The dedicated load control device may then talk directly with devices over the AMI network 140. In other instances, dispatchable loads may include radios, such as WiFi radios, to communicate load requests over a local WiFi network.

When a load shed event occurs (e.g., power allocation is reduced or dispatchable loads are disconnected), users of the utility 120 may be notified of the load shed event. For example, the EVSE 105 may include an LED that is controlled to indicate a load shed event, a message may be provided on a display of the EVSE 105, a test message may be transmitted from the utility 120 to the consumer, or the like. Users of the utility 120 may opt out of load control schemes via an online utility portal or by interfacing with the EVSE 105.

### Load Control Devices Installation and Communication

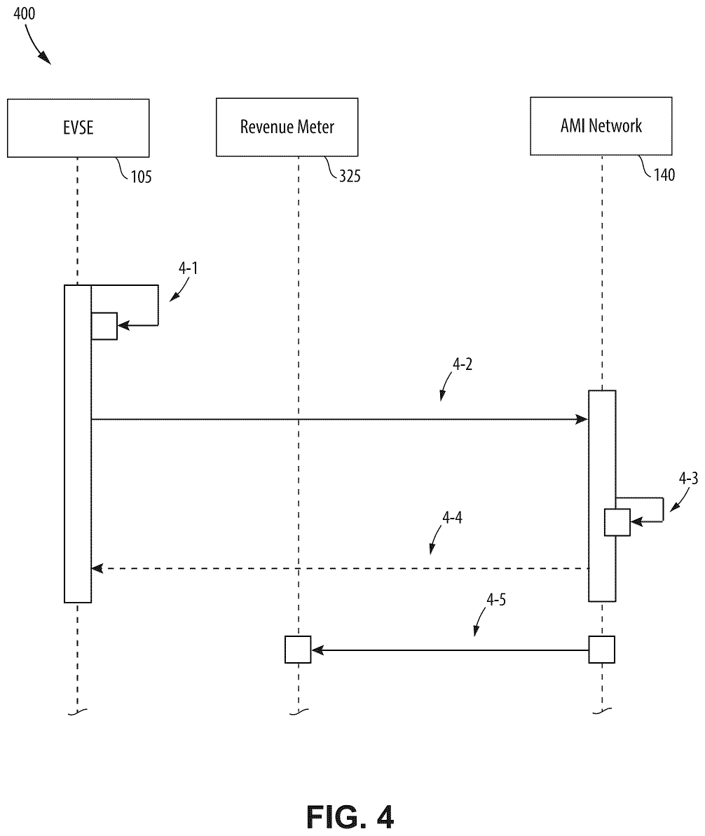

When the EVSE 105 is installed, the EVSE 105 registers as a dispatchable load under the revenue meter 325. The revenue meter 325 is, in turn, under a particular service transformer 310. The registration of the EVSE 105 with a revenue meter 325 is illustrated in FIG. 4. The registration process 400 includes the following steps:

Step 4-1: The EVSE 105 experiences a powerup operation upon installation.

Step 4-2: The EVSE 105 transmits a registration message over the AMI network 140. The registration message may include, for example an identification number of the EVSE 105, an identification number of the AMI meter 210, or the like. The identification number associates the registration message with the particular EVSE 105.

Step 4-3: A base station of the AMI network 140 identifies a revenue meter 325 and service transformer 310 that is upstream from the EVSE 105.

Step 4-4: The base station of the AMI network 140 transmits configuration information to the EVSE 105. The configuration information includes, for example, the revenue meter 325, the service transformer 310, and a cohort with which the EVSE 105 is registered and associated with.

Step 4-5: The base station of the AMI network 140 transmits a notification to the revenue meter 325 indicating the addition of the EVSE 105. The notification may include the identification number of the EVSE 105.

Following the registration process 400, the revenue meter 325 is capable of transmitting commands to the EVSE 105, including shed load commands instructing the EVSE 105 to reduce power drawn from the service power 315.

While the illustrated registration process 400 includes the EVSE 105 communicating with an AMI base station, in some instances, the EVSE 105 instead communicates directly with the revenue meter 325.

When installing a load control device to a dispatchable load, the installer is expected to keep installation records and identify which devices are wired to which ports. The registration of a load control device 506 is illustrated in FIG. 5. The registration process 500 includes the following steps:

Step 5-1: A building automation control system 502 configures, based on user input, a prioritization scheme for emergency load shedding.

Step 5-2: A load control device 506 is connected to the building automation control system 502. The load control device 506 may connect to the building automation control system 502 via either a wired connection (for example, ethernet) or a wireless connection (for example, a WiFi connection).

Step 5-3: The load control device 506 interfaces and connects with dispatchable load 504.

Step 5-4: The load control device 506 configures a communication link with the dispatchable load 504.

Step 5-5: An installer of the load control device 506 connects with any wired loads connected to the load control device 506.

Step 5-6: The load control device 506 transmits a registration message over the AMI network 140. The registration message may include, for example an identification number of the load control device 506. The identification number associates the registration message with the particular load control device 506.

Step 5-7: The base station of the AMI network 140 transmits configuration information to the load control device 506. The configuration information includes, for example, the revenue meter 325 with which the load control device 506 is registered and associated with.

Step 5-8: The base station of the AMI network 140 transmits a notification to the revenue meter 325 indicating the addition of the load control device 506. The notification may include the identification number of the load control device 506.

In some instances, a building automation control system may not be present. Accordingly, in such instances, step 5-1 and step 5-2 may be omitted. Additionally, in some instances, a communication port may not be present between the dispatchable load 504 and the load control device 506. In such instances, step 5-3 and step 5-4 may be omitted.

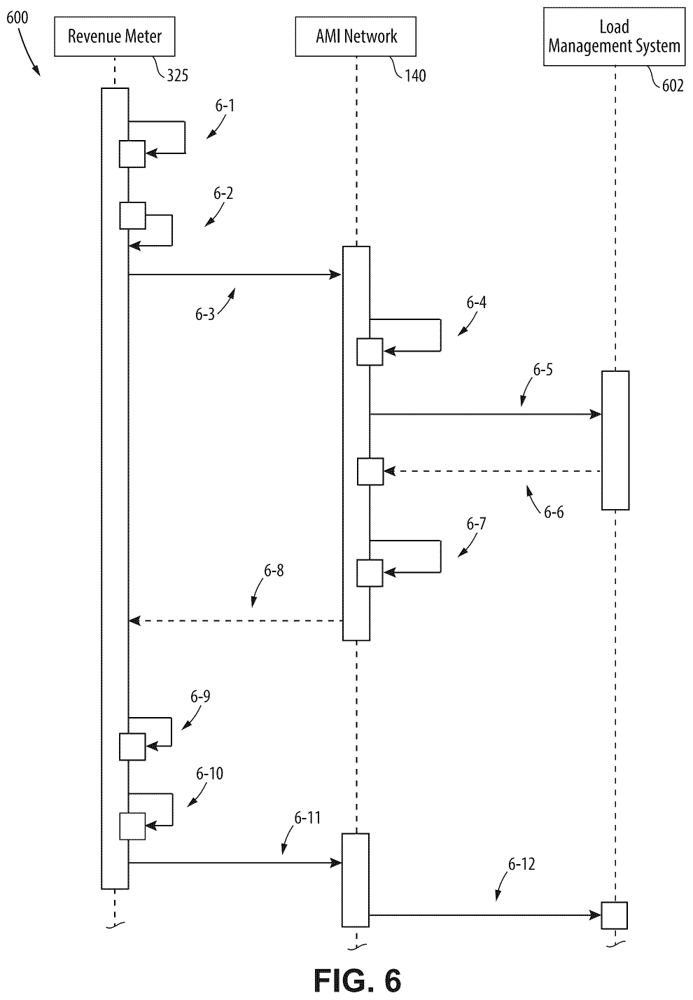

When a revenue meter 325 is installed, the revenue meter 325 registers under a particular service transformer 310. The revenue meter 325 is added to a cohort group under the service transformer and may be identified as the cohort leader. In some instances, the first revenue meter 325 added under a service transformer 310 is defined as the cohort leader. The registration of a revenue meter 325 is illustrated in FIG. 6. The registration process 600 includes the following steps:

Step 6-1: An installer of the revenue meter 325 wires loads to interface boards and records numbering of said interface boards.

Step 6-2: The revenue meter 325 experiences a power on operation.

Step 6-3: The revenue meter 325 transmits a registration message over the AMI network 140. The registration message may include, for example an identification number of the revenue meter 325. The identification number associates the registration message with the particular revenue meter 325.

Step 6-4: A base station of the AMI network 140 identifies an upstream service transformer 310 or the revenue meter 325 and identifies the kVA rating of the service transformer 310.

Step 6-5: The base station of the AMI network 140 transmits a request to a load management system 602 requesting a cohort leader for the revenue meter 325 that is associated with the service transformer 310. The load management system 602 may be, for example, a server associated with the utility 120.

Step 6-6: The load management system 602 returns an indication (for example, an identification number) of the cohort leader to the base station of the AMI network 140.

Step 6-7: The base station of the AMI network 140 adds the revenue meter 325 to the cohort group.

Step 6-8: The base station of the AMI network 140 transmits configuration information to the revenue meter 325. The configuration information includes, for example, the power limitation of the associated service transformer 310, a cohort group identification number, a cohort leader identification number, and the like.

Step 6-9: An installer of the revenue meter 325 identifies a wiring scheme of an interface board associated with the revenue meter 325.

Step 6-10: An installer of the revenue meter 325 sets a load shed prioritization scheme for the revenue meter 325. In some instances, an operator of the revenue meter 325 sets the load shed prioritization scheme (for example, via a connected device such as a mobile phone). The load shed prioritization scheme indicates which connected loads are shed first during load shed operations.

Step 6-11: The revenue meter 325 transmits the wiring scheme and the prioritization scheme over the AMI network 140.

Step 6-12: The wiring scheme and the prioritization scheme of the revenue meter 325 are received by the load management system 602.

In some instances, the steps 6-1, 6-9, 6-10, 6-11, and 6-12 are only performed when an input/output board (for example a serial input/output board or a multi-input/output board) is implemented for the revenue meter 325. The revenue meter 325 identifies which devices are connected to which ports of the input/output board, and reports the devices and the ports of the devices to the load management system 602.

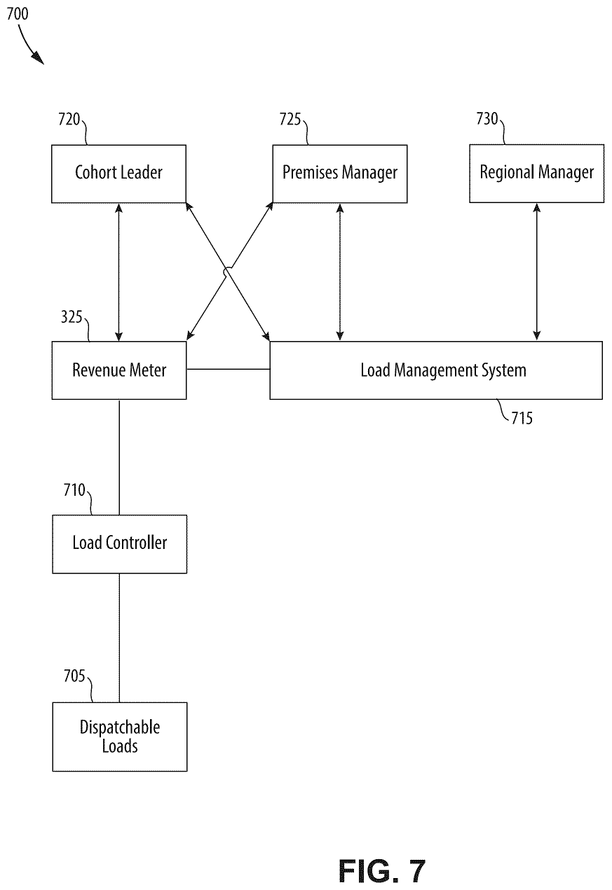

Additional control systems may be implemented with revenue meters taking on roles beyond a cohort leader. For example, beyond a cohort leader, revenue meters may be configured as a premises manger or a regional manager. FIG. 7 illustrates a load control system 700 including, among other things, dispatchable loads 705 connected to a load controller 710 and a revenue meter 325 connected between the load controller 710 and the load management system 715. The load control system 700 also includes a cohort leader 720, a premises manger 725, and a regional manager 730. The cohort leader 720, the premises manager 725, and the regional manager 730 may each be revenue meters that are assigned each respective role. In the example of FIG. 7, the cohort leader 720 is communicatively connected to the revenue meter 325 and the load management system 715. The premises manager 725 is communicatively connected to the revenue meter 325 and the load management system 715. The regional manager 730 is communicatively connected to the load management system 715.

The load management system 715 is configured to service the needs of a local utility by imposing constraints on loads (such as the dispatchable loads 705) and protect utility assets. The load management system 715 may receive load shedding commands from the cohort leader 720, the premises manager 725, and/or the regional manager 730.

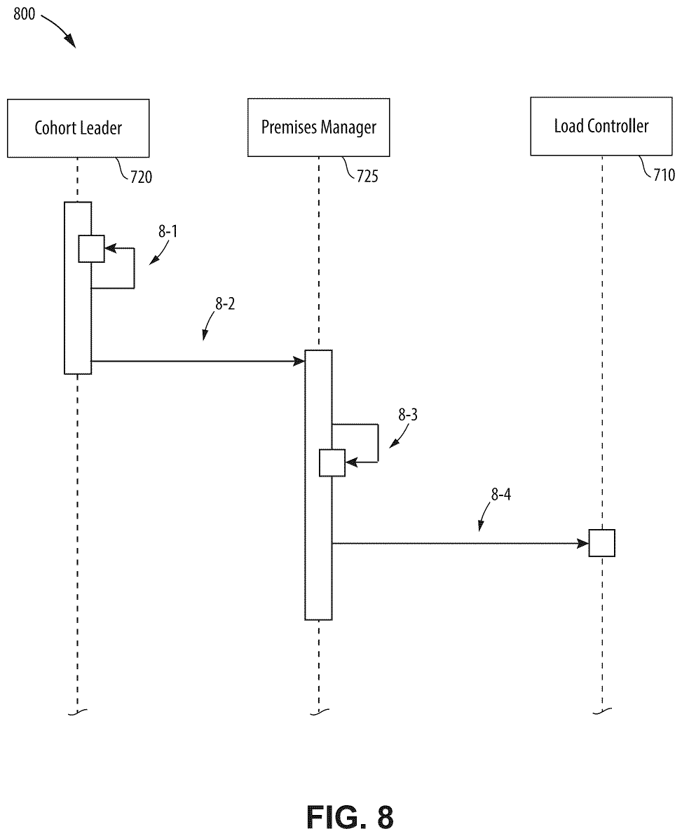

The premises manager 725 enforces power constraints imposed by the cohort leader 720. For example, the premises is limited to consume no more power than the service power 315 can provide. The cohort leader 720 monitors the load on the service transformer 310 and may command the premises manager 725 to operate at a different threshold level. In the example of FIG. 7, the cohort leader 720 communicates with the premises manger 725 via the revenue meter 325 or the load management system 715. In other instances, the cohort leader 720 communicates directly with the premises manager 725. The operation of the premises manager 725 is provided in FIG. 8. The operation process 800 includes the following steps:

Step 8-1: The cohort leader 720 updates power restrictions based on instructions received from the load management system 715. In some instances, the cohort leader 720 updates power restrictions based on instantaneous demand values received from the premises manager 725.

Step 8-2: The cohort leader 720 transmits an indication indicative of the updated power restrictions to the premises manager 725.

Step 8-3: The premises manager 725 measures the instantaneous power of the cohort and compares the instantaneous power to allocated power. Step 8-3 may occur periodically over time (for example, every minute).

Step 8-4: The premises manger 725 transmits power allocation updates to a load controller 710. The load controller 710 may be associated with a load control device such as the EVSE 105. In some instances, the premise manger 725 transmits power allocation updates only when the power allocation for devices has changed or when a power outage has occurred. In some instances, the premise manager 725 performs Step 8-3 for each connected load control device.

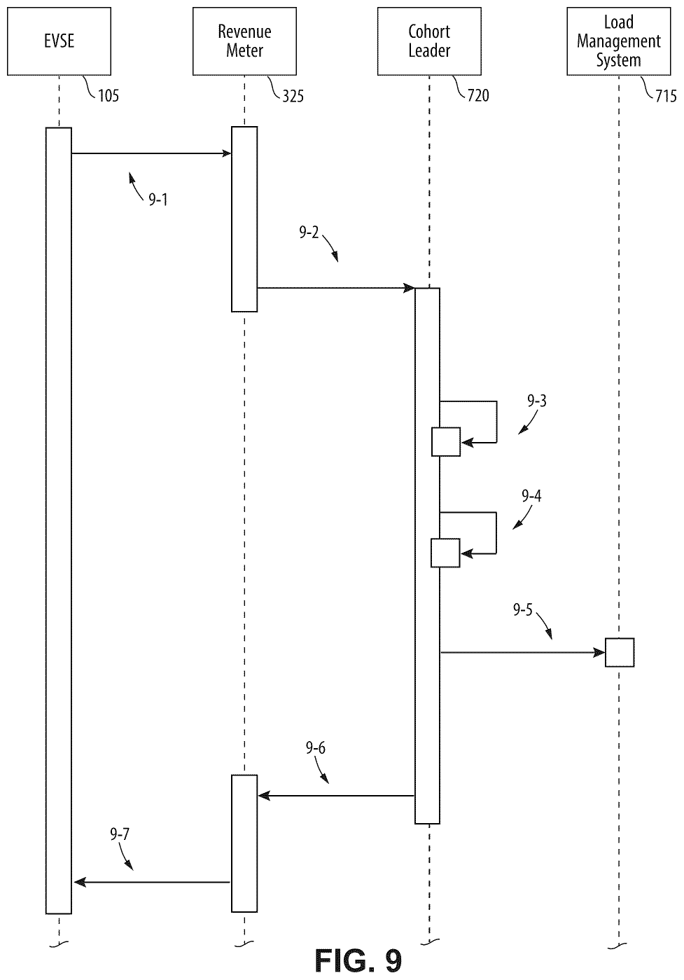

The operation of the cohort leader 720 is provided in FIG. 9. While FIG. 9 refers to an EVSE 105, the EVSE 105 may be replaced with any dispatchable load. FIG. 9 includes a meter data management system 900. The meter data management system 900 may be a server associated with the utility that stores data (e.g., meter readings, load shed events) for different meters associated with the utility 120. The meter data management system 900 may allow an operator of the utility 120 to interface with the connected meters. In some instances, the meter data management system 900 validates received meter readings. The operations of the meter data management system 900 may be performed by the lad management system 715. The operation process 900 includes the following steps:

Step 9-1: The EVSE 105 transmits a charging request to the revenue meter 325. The charging request may include a required power level to perform charging of an electric vehicle 110 connected to the EVSE 105.

Step 9-2: The revenue meter 325 transmits a meter reading to the cohort manager 720. The meter reading may indicate power requests from each connected dispatchable load 705. While only a single revenue meter 325 is illustrated in FIG. 9, all revenue meters 325 connected to the cohort manager 720 transmit their own respective meter reading.

Step 9-3: The cohort manager 720 computes the current load, projected load, and margin for the connected revenue meters 325.

Step 9-4: The cohort manager 720 apportions power according to the selected rationing rule.

Step 9-5: The cohort manager 720, when the service transformer 310 becomes fully loaded or ceases to be fully loaded, transmits a status update to the meter data management system 900.

Step 9-6: The cohort manager 720 transmits apportioned power indicators to the revenue meters 325. Accordingly, each revenue meter 325 is instructed to draw a certain amount of power from the service transformer 310.

Step 9-7: The revenue meter 325 enables charging of the EVSE 105. Enabling charging may include initiating charging, setting a duty cycle of charging current, and setting a charging duration.

With respect to operation process 900, on-premises revenue meters and load control devices may communicate peer-to-peer as well as communicate with devices over the off-premises AMI network 140. Load control devices, such as the EVSE 105, communicate their potential to add or reduce power from the current load to the revenue meter 325. The revenue meter 325 communicates data periodically with the cohort leader 720.

Periodically (for example, every minute, every 5 minutes, etc.), the revenue meter 325 reports a current power usage (in kVA) and requested power usage (in kVA) to the cohort leader 720. The cohort leader 720 sums up the present loads to determine the load on the service transformer 310. As the cohort leader 720 itself is a revenue meter, the present load includes the load of the cohort leader 720. The cohort leader 720 also sums the requested power usage to determine a required power level from the service transformer 310. The cohort leader 720 subtracts the current power usage from the rating of the service transformer 310 to determine the current power margin. The cohort leader 720 subtracts the requested power usage from the current power usage to determine the projected power margin. If there is a deficit between the projected power margin and the current power margin, marginal power is rationed within the service cohort, and the cohort leader 720 indicates to each revenue meter 325 a permitted power draw.

FIG. 9 illustrates devices that communicate locally to monitor and control power load. When a change in the status of the service transformer 310 occurs, and power rationing among connected dispatchable loads is either starting or ending, the AMI network notifies individual homeowners of the change in power distribution.

The load management system 715 works to manage loads at the utility level by means of direct load control commands. The load management system 715 communicates with load control devices (for example, the EVSE 105) and revenue meters 325 over the AMI network 140. The load control devices attach to loads that have been identified as non-critical loads that may be shed in the time of a constrained power event. The fact that the load management system 715 can reach these loads and control them makes them dispatchable loads (e.g., the dispatchable loads 705).

The load management system 715 may be associated with the utility 120 and has visibility to the entire needs of the utility 120. The load management system 715 therefore may communicate commands, such as load shed commands, to any one load control device, a group of load control devices, or revenue meters within the service range. Once a regional target is identified by the utility 120, the load management system 715 issues commands accordingly. In some instances, the load management system 715 transmits load shed commands to all control devices in a service territory in the event of an emergency. Additionally, the load management system 715 may issue commands randomly to keep the total load on a service transformer 310 reduced.

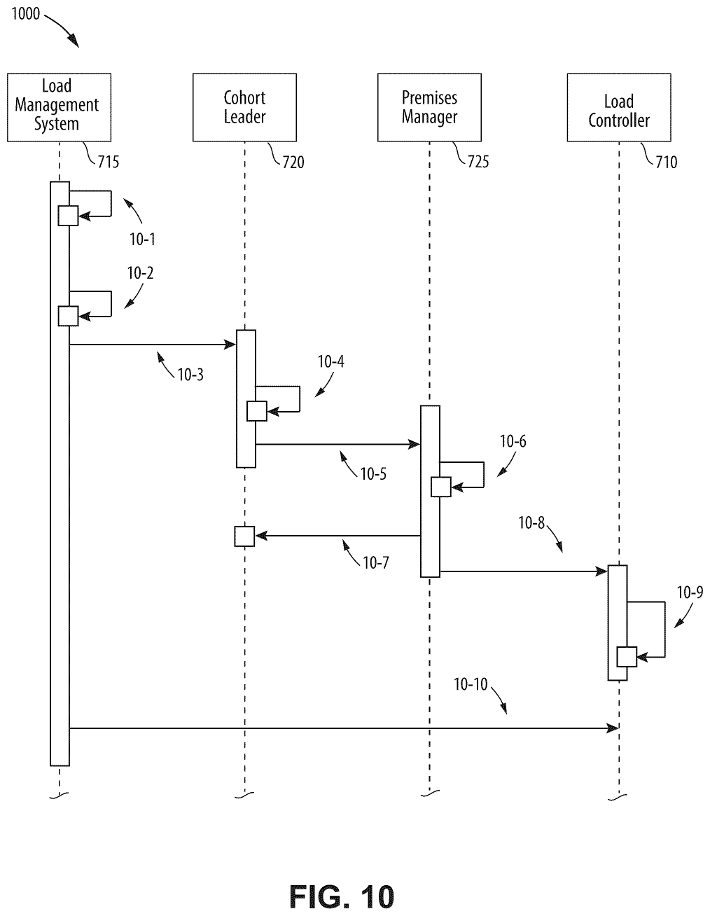

The operation of the load management system 715 is provided in FIG. 10. The operation process 1000 includes the following steps:

Step 10-1: The load management system 715 identifies a power generation shortfall or substation overload. In some instances, the load management system 715 receives a notification from another device indicating the power generation shortfall.

Step 10-2: The load management system 715 identifies a power limit of the service transformer 310.

Step 10-3: The load management system 715 transmits the power limit of the service transformer 310 to the cohort leader 720. The power limit may indicate, for example, a limit on the power allowed to be drawn from the cohort leader 720.

Step 10-4: The cohort leader 720 computes premises allocation.

Step 10-5: The cohort leader 720 transmits the premises allocation to the premises manager 725.

Step 10-6: The premises manager 725 monitors the load of the service transformer 310.

Step 10-7: The premises manager 725 transmits an indication of a change in the power level of the service transformer 310 to the cohort leader 720.

Step 10-8: The premises manager 725 transmits, to the load controller 710, a duty cycle at which to draw power from the service transformer 310.

Step 10-9: The load controller 710 sheds or restores loads based on the command from the premises manager 725.

Step 10-10: The load management system 715 directly instructs the load controller 710 to shed loads. The load management system 715 may command the load controller 710 by providing a start time for load shedding, a stop time for load shedding, a duty cycle at which to draw power from the service transformer 310, a time diversity offset, or the like.

FIG. 10 shows that, in addition to the normal location operation of servicing power and monitoring the service transformer 310, a back-office system may also provide control. For example, a decision made in a utility back office may be sent out for enforcement. One approach is to impose targeted power limits at the service transformer 310. These limits may be provided to the cohort leader 720 and are managed locally. Another approach is to manage loads centrally and have the load management system 715 issue commands directly to load controllers 710. Load controllers 710 may be, for example, controllers and devices that are connected to the dispatchable loads 705.

Thus, the application provides, among other things, load management for electric grids. Various features and advantages of the application are set forth in the following claims.

What is claimed is:

1. A load management system comprising:
a load management server associated with a utility; and
a first revenue meter communicatively connected to the load management server, the first revenue meter including a first controller configured to:
determine a user priority of load distribution to a plurality of devices in communication with the first revenue meter,
determine a current power drawn by the plurality of devices,
transmit, in response to a load shed event and based on the user priority, a load shed command to the plurality of devices indicating a new amount of power to be drawn by the plurality of devices, the new amount of power to be drawn being less than the current power drawn by the plurality of devices, and
transmit an indication of the load shed event to the load management server.

2. The load management system of claim 1, further comprising:
a service transformer configured to receive power from the utility,
wherein the first controller is further configured to:
monitor an amount of power output by the service transformer.

3. The load management system of claim 2, wherein the first controller is further configured to:
determine the load shed event when the current power drawn by the plurality of devices exceeds a power threshold.

4. The load management system of claim 3, wherein the power threshold is a power rating of the service transformer.

5. The load management system of claim 1, wherein the first controller is further configured to:
transmit a registration message to the load management server, the registration message including an identification number of the first revenue meter.

6. The load management system of claim 1, further comprising:
a second revenue meter communicatively connected to the load management server, the second revenue meter including a second controller configured to:
transmit a request to the load management server requesting an identification of the first revenue meter, and
establish communication with the first revenue meter.

7. The load management system of claim 6, wherein the first controller is further configured to:
receive, from the second revenue meter, a request for power, and
transmit a power command to the second revenue meter indicating a permitted amount of power draw.

8. The load management system of claim 1, wherein the user priority indicates an order in which power is reduced to the plurality of devices.

9. The load management system of claim 1, wherein the plurality of devices includes an electric vehicle.

10. A load management system comprising:
a service transformer configured to provide power, wherein the service transformer includes a transformer rating indicating a maximum providable power;
a plurality of revenue meters, each revenue meter of the plurality of revenue meters coupled to at least one load and configured to receive power from the service transformer; and
a cohort leader communicatively connected to each revenue meter of the plurality of revenue meters, the cohort leader including a controller configured to:
receive a plurality of power requests, each power request being received from one of the plurality of revenue meters,
determine, based on the plurality of power requests and the transformer rating, a plurality of power allocations, and
transmit one power allocation of the plurality of power allocations to each revenue meter included in the plurality of revenue meters.

11. The load management system of claim 10, wherein each power request is a percentage of power available from the service transformer, and wherein the controller is further configured to:
multiply, for each power request, the power request and the transformer rating to determine the plurality of power allocations.

12. The load management system of claim 10, wherein the controller is further configured to:
receive a plurality of instantaneous power measurements, each instantaneous power measurement received from one of the plurality of revenue meters and indicative of the current power draw of the associated revenue meter,
sum the plurality of instantaneous power measurements to determine a current instantaneous power measurement, and
subtract the current instantaneous power measurement from the transformer rating to determine a margin power available to each revenue meter.

13. The load management system of claim 12, wherein each power request is a percentage of power available from the service transformer, and wherein the controller is further configured to:
multiply the margin power with the power request to determine a power portion, and
add, for each instantaneous power measurement, the power portion to the instantaneous power measurement to determine the plurality of power allocations.

14. The load management system of claim 10, wherein the cohort leader is connected to an electric vehicle supply equipment (EVSE), and wherein the controller is further configured to:
transmit a shed load command to the EVSE instructing the EVSE to reduce power drawn from the service transformer.

15. The load management system of claim 10, wherein the controller is further configured to:
determine whether a first revenue meter of the plurality of revenue meters is exceeding a respective power allocation, and
log, in a memory of the controller, an indication of the first revenue meter exceeding the respective power allocation.

16. A method for controlling power draw from a service transformer, the method comprising:
determining, with a first revenue meter, a user priority of load distribution to a plurality of devices in communication with the first revenue meter;
determining a current power drawn by the plurality of devices;
transmitting, in response to a load shed event and based on the user priority, a load shed command to the plurality of devices indicating a new amount of power to be drawn by the plurality of devices, the new amount of power to be drawn being less than the current power drawn by the plurality of devices, and
transmitting an indication of the load shed event to a load management server associated with the service transformer.

17. The method of claim 16, further comprising:
determining the load shed event when the current power drawn by the plurality of devices exceeds a power rating of the service transformer.

18. The method of claim 17, further comprising:
transmitting a registration message to the load management server, the registration message including an identification number of the first revenue meter, and
receiving, from the load management server, configuration information including the power rating of the transformer.

19. The method of claim 16, further comprising:
transmitting, with a second revenue meter, a request to the load management server requesting an identification of the first revenue meter, and
establishing, with the second revenue meter, communication with the first revenue meter.

20. The method of claim 19, further comprising:
receiving, with the first revenue meter, a request for power from the second revenue meter, and
transmitting, with the first revenue meter, a power command to the second revenue meter indicating a permitted amount of power draw.
